(19) United States
(12) Patent Application Publication
(10) Pub. No.: US 2017/0031451 A1
(43) Pub. Date: Feb. 2, 2017

(54) MOBILE TERMINAL AND CONTROL METHOD THEREOF

(71) Applicant: LG ELECTRONICS INC., Seoul (KR)

(72) Inventor: Sangjun JIN, Seoul (KR)

(21) Appl. No.: 15/070,654

(22) Filed: Mar. 15, 2016

(30) Foreign Application Priority Data
Jul. 29, 2015 (KR) 10-2015-0107538

(51) Int. Cl. G06F 3/01; G06F 3/041; G06F 21/36; G06F 3/0481

(52) U.S. Cl. CPC G06F 3/017; G06F 3/04817; G06F 3/0416; G06F 21/36

(57) ABSTRACT

Provided are a mobile terminal capable of sensing a user's gesture and a control method thereof. The mobile terminal includes a control unit configured to store data for executing a preset control operation when a preset gesture is applied, a sensing unit configured to, when the preset gesture is applied again, calculate a first sensing value based on the preset gesture, and a wireless communication unit configured to receive a second sensing value calculated in an external terminal by the preset gesture from the external terminal, wherein when the first sensing value and the second sensing value are within a preset specific range, the control unit executes the preset control operation on the basis of the data.

### CROSS-REFERENCE TO RELATED APPLICATION

Pursuant to 35 U.S.C. §119(a), this application claims the benefit of earlier filing date and right of priority to Korean Application No. 10-2015-0107538, filed on Jul. 29, 2015, the contents of which is incorporated by reference herein in its entirety.

### BACKGROUND OF THE INVENTION

1. Field of the Invention

The present disclosure relates to a mobile terminal capable of sensing a user's gesture and a control method thereof.

2. Background of the Invention

Terminals may be generally classified as mobile/portable terminals or stationary terminals according to their mobility. Mobile terminals may also be classified as handheld terminals or vehicle mounted terminals according to whether or not a user can directly carry the terminal.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

As functions of terminals become more diversified, terminals are implemented in the form of a multimedia player including composite functions such as capturing images or video, reproducing music or video files, playing games, receiving broadcast signals, and the like.

In order to support and increase functions of terminals, improvement of structural parts and/or software parts of terminals may be taken into consideration.

Terminals are frequently used in our daily lives. As a result, when someone else uses a terminal of a user, personal information included in the user's terminal may be leaked.

Also, in a case in which a new terminal is used or in a case in which a different terminal is temporarily used, a user setting should be performed newly or an application should be re-installed, causing user inconvenience.

### SUMMARY OF THE INVENTION

Therefore, an aspect of the detailed description is to provide a mobile terminal capable of executing a specific control operation in a case in which a sensing value of the terminal and a sensing value of an external terminal are within a preset range, and a control method thereof.

To achieve these and other advantages and in accordance with the purpose of this specification, as embodied and broadly described herein, a mobile terminal may include: a control unit configured to store data for executing a preset control operation when a preset gesture is applied; a sensing unit configured to, when the preset gesture is applied again, calculate a first sensing value based on the preset gesture; and a wireless communication unit configured to receive a second sensing value calculated in an external terminal by the preset gesture from the external terminal, wherein when the first sensing value and the second sensing value are within a preset specific range, the control unit executes the preset control operation on the basis of the data.

In an embodiment of the present disclosure, the wireless communication unit may receive a sensing value calculated according to the preset gesture in the watch type mobile terminal worn on the wrist that is holding the terminal, as a second sensing value.

In another embodiment of the present disclosure, the wireless communication unit may receive authentication information authenticating a user who has made the preset gesture from the watch type mobile terminal.

In another embodiment of the present disclosure, in a state in which the authentication information is received and the first sensing value and the second sensing value are within the preset specific range, the control unit may re-authenticate the user such that the preset control operation is executed on the basis of the data.

In another embodiment of the present disclosure, in a state in which the authentication information is received and the first sensing value and the second sensing value are within the preset specific range, the control unit may execute a preset banking transaction on the basis of the data.

In another embodiment of the present disclosure, in a state in which the authentication information is received and the first sensing value and the second sensing value are within the preset specific range, the control unit may execute a preset application on the basis of the data.

In another embodiment of the present disclosure, in a state in which the authentication information is received and the first sensing value and the second sensing value are within the preset specific range, the control unit may execute log in to a preset application on the basis of the data.

In another embodiment of the present disclosure, in a state in which the authentication information is received and the first sensing value and the second sensing value are within the preset specific range, the control unit may output preset visual information on the basis of the data.

In another embodiment of the present disclosure, in a state in which the authentication information is received and the first sensing value and the second sensing value are within the preset specific range, the control unit may output an icon of a preset application on the basis of the data.

In another embodiment of the present disclosure, when the preset gesture is applied, the wireless communication unit may transmit an environment setting value of the terminal to the watch type mobile terminal.

In another embodiment of the present disclosure, in a state in which the authentication information is received and the first sensing value and the second sensing value are within the preset specific range, the control unit may set an environment setting value of the terminal with a value transmitted from the watch type mobile terminal.

In another embodiment of the present disclosure, after a preset touch input is applied to visual information output on the display unit, when the preset-gesture is applied, the wireless communication unit may transmit the visual information to the watch type mobile terminal.

In another embodiment of the present disclosure, after a preset touch input is applied to one region of a display unit provided in the watch type mobile terminal, when the preset gesture is applied again, the control unit may control the watch type mobile terminal to output the visual information on the one region.

In another embodiment of the present disclosure, in a state in which the authentication information is received and the first sensing value and the second sensing value are within a preset first specific range, the control unit may perform a preset first control operation on the basis of the data, and in a state in which the authentication information is received and the first sensing value and the second sensing value are within a preset second specific range, the control unit may perform a preset second control operation on the basis of the data.

To achieve these and other advantages and in accordance with the purpose of this specification, as embodied and broadly described herein, a method of controlling a mobile terminal may include: (a) storing data for executing a preset control operation when a preset gesture is applied; (b) when the preset gesture is applied again, calculating a first sensing value according to the preset gesture, and receiving a second sensing value calculated by an external terminal according to the preset gesture from the external terminal; and (c) when the first sensing value and the second sensing value are within a preset specific range, executing the preset control operation on the basis of the data.

In an embodiment of the present disclosure, (b) may include: receiving a sensing value calculated according to the preset gesture from the watch type mobile terminal worn on a wrist that is holding a terminal, as the second sensing value.

In another embodiment of the present disclosure, (b) may include: receiving authentication information authenticating a user who has made the preset gesture from the watch type mobile terminal.

In another embodiment of the present disclosure, (c) may include: re-authenticating the user such that the preset control operation is executed on the basis of the data in a state in which the authentication information is received and the first sensing value and the second sensing value are within the preset specific range.

In another embodiment of the present disclosure, (c) may include: executing a preset banking transaction on the basis of the data in a state in which the authentication information is received and the first sensing value and the second sensing value are within the preset specific range.

In another embodiment of the present disclosure, (c) may include: executing a first preset control operation on the basis of the data in a state in which the authentication information is received and the first sensing value and the second sensing value are within a preset first specific range, and executing a second preset control operation on the basis of the data in a state in which the authentication information is received and the first sensing value and the second sensing value are within a preset second specific range.

Further scope of applicability of the present application will become more apparent from the detailed description given hereinafter. However, it should be understood that the detailed description and specific examples, while indicating preferred embodiments of the invention, are given by way of illustration only, since various changes and modifications within the scope of the invention will become apparent to those skilled in the art from the detailed description.

### BRIEF DESCRIPTION OF THE DRAWINGS

The accompanying drawings, which are included to provide a further understanding of the invention and are incorporated in and constitute a part of this specification, illustrate exemplary embodiments and together with the description serve to explain the principles of the invention.

In the drawings:

FIG. 1A is a block diagram of a mobile terminal in accordance with the present disclosure.

FIGS. 1B and 1C are conceptual views of one example of the mobile terminal, viewed from different directions.

FIG. 2 is a perspective view illustrating an example of a watch type mobile terminal related to another embodiment of the present disclosure.

FIG. 3 is a flow chart illustrating a method for controlling a mobile terminal according to an embodiment of the present disclosure.

FIG. 4 is a conceptual view illustrating an embodiment in which a mobile terminal and a watch type mobile terminal have the same sensing value according to an embodiment of the present disclosure.

FIG. 5 is a conceptual view illustrating an embodiment in which a user is authenticated in a watch type mobile terminal.

FIG. 6 is a conceptual view illustrating an embodiment in which payment information is stored by a gesture having the same sensing value.

FIG. 7 is a conceptual view illustrating an embodiment in which payment information is used by a gesture having the same sensing value.

FIG. 8 is a conceptual view illustrating an embodiment in which personal information is stored by a gesture having the same sensing value.

FIG. 9 is a conceptual view illustrating an embodiment in which personal information is used by a gesture having the same sensing value.

FIG. 10 is a conceptual view illustrating an embodiment in which an icon of a preset application is output by a gesture having the same sensing value.

FIG. 11 is a conceptual view illustrating an embodiment in which a brightness value is set by a gesture having the same sensing value.

FIG. 12 is a conceptual view illustrating an embodiment in which text is duplicated by a gesture having the same sensing value.

FIG. 13 is a conceptual view illustrating an embodiment in which text is pasted by a gesture having the same sensing value.

FIG. 14 is a conceptual view illustrating an embodiment in which icons of different applications are output according to sensing values.

FIG. 15 is a conceptual view illustrating an embodiment in which execution screens of different schedule applications are output according to sensing values.

### DETAILED DESCRIPTION OF THE INVENTION

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

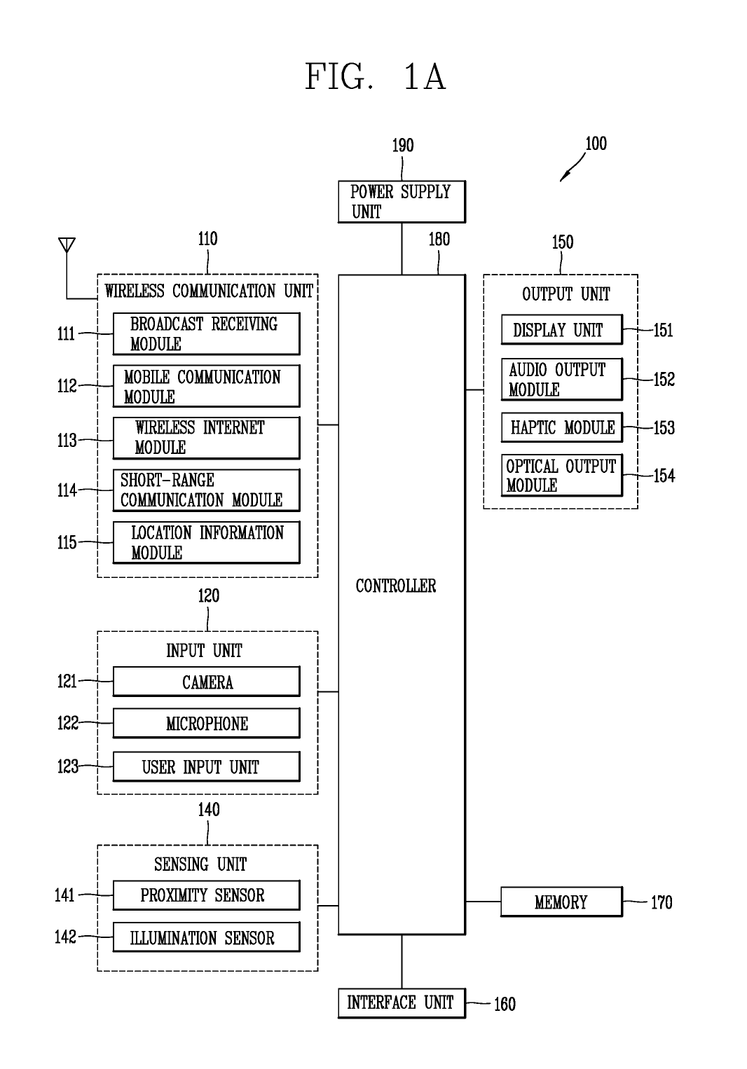

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a control unit 180, and a power supply unit 190. It is understood that implementing all of the illustrated components is not a requirement, and that greater or fewer components may alternatively be implemented.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server.

Further, the wireless communication unit 110 typically includes one or more modules which connect the mobile terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by control unit 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142. If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154.

The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the control unit 180 to perform an operation (or function) for the mobile terminal 100.

The control unit 180 typically functions to control overall operation of the mobile terminal 100, in addition to the operations associated with the application programs. The control unit 180 may provide or process information or functions appropriate for a user by processing signals, data, information and the like, which are input or output by the various components depicted in FIG. 1A, or activating application programs stored in the memory 170. As one example, the control unit 180 controls some or all of the components illustrated in FIGS. 1A-1C according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

At least some of the above components may operate in a cooperating manner, so as to implement an operation or a control method of a glass type terminal according to various embodiments to be explained later. The operation or the control method of the glass type terminal may be implemented on the glass type terminal by driving at least one application program stored in the memory 170.

Referring still to FIG. 1A, various components depicted in this figure will now be described in more detail.

Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the control unit 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal.

As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the control unit 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The control unit 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like). In general, control unit 180 processes data corresponding to proximity touches and proximity touch patterns sensed by the proximity sensor 141, and cause output of visual information on the touch screen. In addition, the control unit 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the control unit 180. Accordingly, the control unit 180 may sense which region of the display unit 151 has been touched. Here, the touch controller may be a component separate from the control unit 180, the control unit 180, and combinations thereof.

In some embodiments, the control unit 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor provided at the display unit 151 may be configured to sense taps in an activated state and a deactivated state, using different methods. The different methods may be associated with an activation period of the touch sensor. More specifically, the touch sensor may be activated with a different period according to an activated state or a deactivated state of the display unit 151. That is, the touch sensor may sense a tap applied thereon, with a different activation period, according to an activated state or a deactivated state of the display unit 151.

For instance, in a deactivated state of the display unit 151, the touch sensor may be activated with a preset period. In this case, the preset period may be a time period more than 0. On the other hand, in an activated state of the display unit 151, the touch sensor may be always operated in an activated state. In this case, an activation period of the touch sensor may be a time period of 0 or very close to 0.

Whether the touch sensor is in an activated state or a deactivated state may be determined based on a power consumption amount of the touch sensor. For instance, if a power consumption amount of the touch sensor is equal to or less than a preset value based on ‘0’, it may be determined that the touch sensor is in a deactivated state. On the other hand, if a power consumption amount of the touch sensor exceeds the preset value based on ‘0’, it may be determined that the touch sensor is in an activated state.

If the display unit 151 is in an activated state (hereinafter, will be referred to as an active mode), the touch sensor may wait for input of taps onto the display unit 151, while maintaining an activated state. On the other hand, if the display unit 151 is in a deactivated state (hereinafter, will be referred to as a doze mode), the touch sensor may be activated at preset periods.

When the preset activation period of the touch sensor is shorter, a sensing speed with respect to taps applied onto the display unit 151 is higher. However, in this case, a power consumption amount of the touch sensor may be increased. On the other hand, when the preset activation period of the touch sensor is longer, a sensing speed with respect to taps applied onto the display unit 151 may be lower, while a power consumption amount of the touch sensor is decreased.

Thus, the preset period may be set so that a sensing speed with respect to taps applied onto the display unit 151 can be high enough not to be recognized by a user, and so that power consumption can be reduced. For instance, the preset period may be set so that the touch sensor in a deactivated state can be activated about 20 times (1 Hz) per second.

While the display unit 151 is in an activated state, the touch sensor may be also in an activated state. In an activated state, the touch sensor may have an activation period (T) of ‘0’ or a value very close to ‘0’. Alternatively, in an activated state, the touch sensor may have an activation period (T) much shorter than that set in a deactivated state of the display unit 151, by several times. That is, the touch sensor may be activated with a different period, according to whether the display unit 151 is in an activated state or a deactivated state.

In a doze mode where the display unit 151 is in a deactivated state and the touch sensor is periodically activated, if a preset touch input (first and second touch inputs consecutively applied onto a predetermined region within a reference time, e.g., a ‘TOCK-TOCK’ touch input) is sensed by the touch sensor, the controller 180 may convert the doze mode into an activate mode where the display unit and the touch sensor are activated.

Moreover, the touch sensor may be driven at a different period according to a state of the display unit 151. For instance, the touch sensor may execute a doze mode when the display unit 151 is in a closed state, and execute an active mode when the display unit 151 is converted from a closed state to an open state.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The control unit 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the control unit. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the control unit 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The control unit 180 may typically control the general operations of the mobile terminal 100. For example, the control unit 180 may set or release a lock state for restricting a user from inputting a control command with respect to applications when a status of the mobile terminal meets a preset condition.

The control unit 180 can also perform the controlling and processing associated with voice calls, data communications, video calls, and the like, or perform pattern recognition processing to recognize a handwriting input or a picture drawing input performed on the touch screen as characters or images, respectively. In addition, the control unit 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

FIGS. 1B and 1C depict certain components as arranged on the mobile terminal. However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject.

As shown in FIG. 1B, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the control unit 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

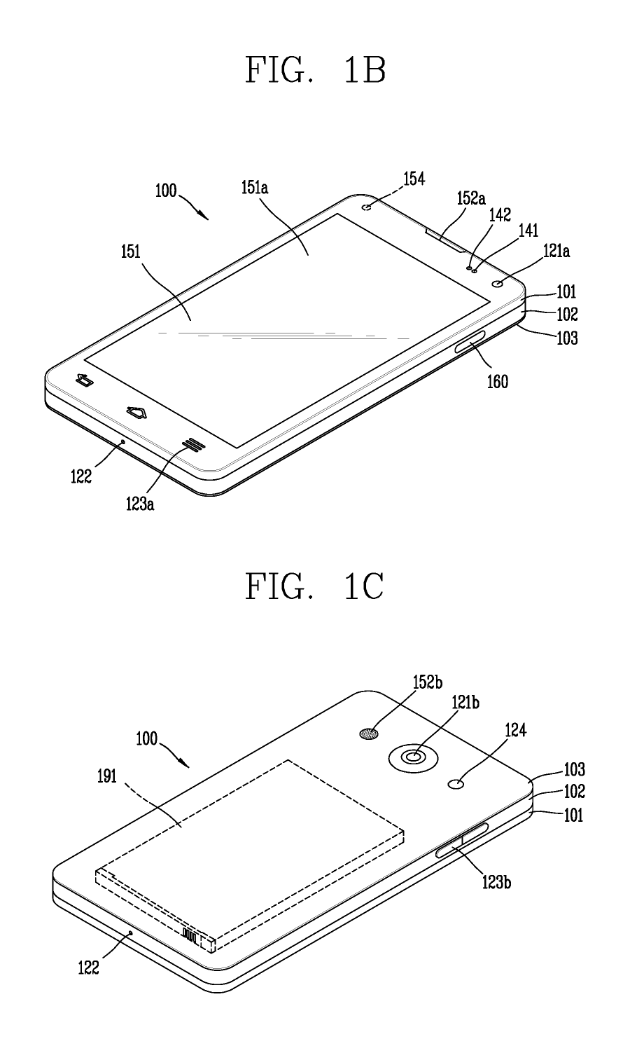

FIG. 2 is a perspective view illustrating one example of a watch type mobile terminal 300 in accordance with another exemplary embodiment.

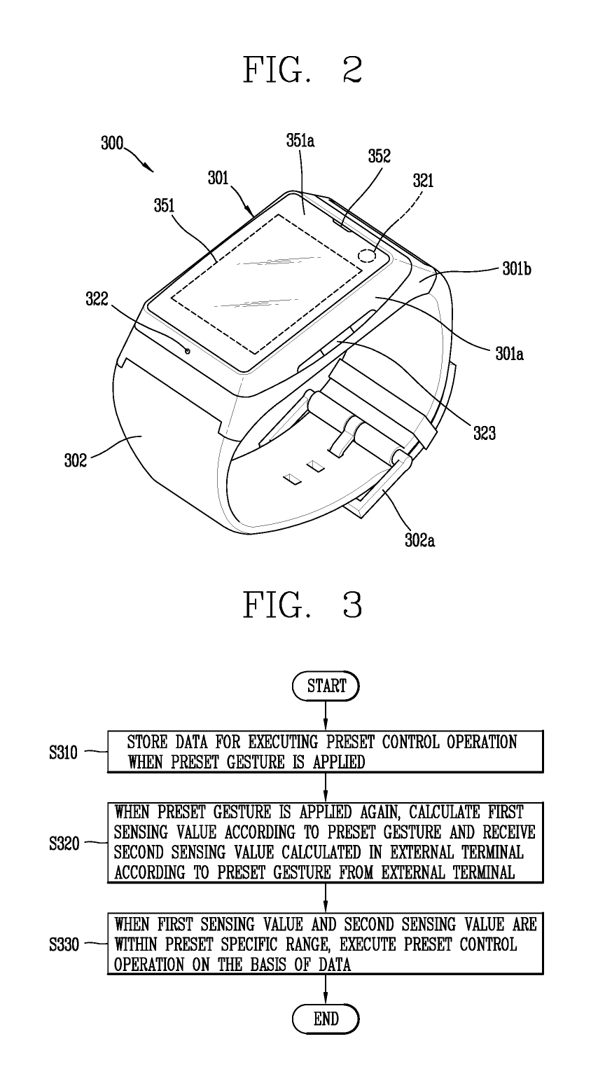

As illustrated in FIG. 3, the watch type mobile terminal 300 includes a main body 301 with a display unit 351 and a band 302 connected to the main body 301 to be wearable on a wrist. In general, the watch type mobile terminal 300 may be configured to include features that are the same or similar to that of mobile terminal 100 of FIGS. 1A-1C.

The main body 301 may include a case having a certain appearance. As illustrated, the case may include a first case 301a and a second case 301b cooperatively defining an inner space for accommodating various electronic components. Other configurations are possible. For instance, a single case may alternatively be implemented, with such a case being configured to define the inner space, thereby implementing a mobile terminal 300 with a uni-body.

The watch type mobile terminal 300 can perform wireless communication, and an antenna for the wireless communication can be installed in the main body 301. The antenna may extend its function using the case. For example, a case including a conductive material may be electrically connected to the antenna to extend a ground area or a radiation area.

The display unit 351 is shown located at the front side of the main body 301 so that displayed information is viewable to a user. In some embodiments, the display unit 351 includes a touch sensor so that the display unit can function as a touch screen. As illustrated, window 351a is positioned on the first case 301a to form a front surface of the terminal body together with the first case 301a.

The illustrated embodiment includes audio output module 352, a camera 321, a microphone 322, and a user input unit 323 positioned on the main body 301. When the display unit 351 is implemented as a touch screen, additional function keys may be minimized or eliminated. For example, when the touch screen is implemented, the user input unit 323 may be omitted.

The band 302 is commonly worn on the user's wrist and may be made of a flexible material for facilitating wearing of the device. As one example, the band 302 may be made of fur, rubber, silicon, synthetic resin, or the like. The band 302 may also be configured to be detachable from the main body 301. Accordingly, the band 302 may be replaceable with various types of bands according to a user's preference.

In one configuration, the band 302 may be used for extending the performance of the antenna. For example, the band may include therein a ground extending portion (not shown) electrically connected to the antenna to extend a ground area.

The band 302 may include fastener 302a. The fastener 302a may be implemented into a buckle type, a snap-fit hook structure, a Velcro® type, or the like, and include a flexible section or material. The drawing illustrates an example that the fastener 302a is implemented using a buckle.

Hereinafter, exemplary embodiments related to a control method that may be implemented in the mobile terminal configured as described above will be described with reference to the accompanying drawings. It will be apparent to those skilled in the art that modifications and variations can be made without departing from the spirit and scope of the invention.

FIG. 3 is a flow chart illustrating a method for controlling a mobile terminal according to an embodiment of the present disclosure.

Referring to FIG. 3, first, data for executing a preset control operation is stored on the basis of an application of a preset gesture in step S310.

Next, when the preset gesture is applied again, a first sensing value based on the preset gesture is calculated, and a second sensing value calculated in an external terminal based on the preset gesture is received from the external terminal in step S320.

In detail, the sensing unit 140 may calculate a sensing value based on a preset gesture. In an embodiment, the sensing value may be calculated by an acceleration sensor, a G sensor, a gyroscrope sensor, a motion sensor, and the like.

In another embodiment, step S320 may include a step in which a sensing value calculated on the basis of the preset gesture in a watch type mobile terminal worn on a user's wrist that holds the terminal is received as a second sensing value.

In another embodiment, step S320 may include a step in which authentication information authenticating the user, who made the preset gesture, is received from the watch type mobile terminal.

Thereafter, when the first sensing value and the second sensing value are within a preset specific range, the preset control operation is executed on the basis of the data in step S330.

In an embodiment, step S330 may include a step in which, in a state in which the authentication information is received and the first sensing value and the second sensing value are within the preset specific range, the user is re-authenticated to execute the preset control operation on the basis of the data.

In another embodiment, step S330 may include a step in which, in a state in which the authentication information is received and the first sensing value and the second sensing value are within the preset specific range, a preset banking transaction may be executed on the basis of data.

In another embodiment, step S330 may include a step in which, in a state in which the authentication information is received and the first sensing value and the second sensing value are within a preset first specific range, a preset first control operation is executed on the basis of the data, and in a state in which the authentication information is received and the first sensing value and the second sensing value are within a second preset specific range, a preset second control operation is executed on the basis of the data.

Hereinafter, a specific embodiment will be described with reference to FIG. 1A.

The control unit 180 may store data for executing a preset control operation on the basis of an application of a preset gesture.

When the preset gesture is applied again, the sensing unit 140 may calculate a first sensing value based on the preset gesture on the basis of the preset gesture applied again.

The wireless communication unit 110 may receive the second sensing value calculated by the external terminal on the basis of the preset gesture from the external terminal.

Thus, on the basis of the first sensing value and the second sensing value within the preset specific range, the control unit 180 may execute the preset control operation on the basis of the data.

In an embodiment, the wireless communication unit 110 may receive the sensing value calculated on the basis of the preset gesture in the watch type mobile terminal worn on the wrist holding the terminal, as the second sensing value.

In another embodiment, the wireless communication unit 110 may receive authentication information authenticating the user who has made the preset gesture from the watch type mobile terminal.

In another embodiment, in a state in which the authentication information is received and the first sensing value and the second sensing value are within a preset specific range, the user may be re-authenticated such that the preset control operation is executed on the basis of the data.

In another embodiment, in a state in which the authentication information is received and the first sensing value and the second sensing value are within the preset specific range, the control unit 180 may execute a preset banking transaction on the basis of the data.

In another embodiment, in a state in which the authentication information is received and the first sensing value and the second sensing value are within the preset specific range, the control unit 180 may execute a preset application on the basis of the data.

In another embodiment, in a state in which the authentication information is received and the first sensing value and the second sensing value are within the preset specific range, the control unit 180 may execute log-in to a preset application on the basis of the data.

In another embodiment, in a state in which the authentication information is received and the first sensing value and the second sensing value are within the preset specific range, the control unit 180 may output preset visual information on the basis of the data.

In another embodiment, in a state in which the authentication information is received and the first sensing value and the second sensing value are within the preset specific range, the control unit 180 may output an icon of a preset application on the basis of the data.

In another embodiment, when the preset gesture is applied, the wireless communication unit 110 may transmit an environment setting value of the terminal to the watch type mobile terminal.

In another embodiment, in a state in which the authentication information is received and the first sensing value and the second sensing value are within the preset specific range, the control unit 180 may set an environment setting value of the terminal 100 with a value transmitted from the watch type mobile terminal.

In another embodiment, when a preset touch input is applied to visual information output on the display unit 151 and the preset gesture is subsequently applied, the wireless communication unit 110 may transmit the visual information to the watch type mobile terminal.

In another embodiment, when a preset touch input is applied to one region of the display unit provided in the watch type mobile terminal and the preset gesture is subsequently applied, the control unit 180 may control the watch type mobile terminal to output the visual information on the one region.

In another embodiment, in a state in which the authentication information is received and the first sensing value and the second sensing value are within a preset first specific range, the control unit 180 may execute a preset first control operation on the basis of the data, and in a state in which the authentication information is received and the first sensing value and the second sensing value are within a second preset specific range, the control unit 180 may execute a preset second control operation on the basis of the data.

As described above, the external terminal may be a watch type mobile terminal 300 worn on the wrist which holds the mobile terminal 100 in hand. That is, the wireless communication unit 110 may receive a sensing value calculated on the basis of the preset gesture in the watch type mobile terminal 300 worn on the wrist that holds the terminal 100, as the second sensing value.

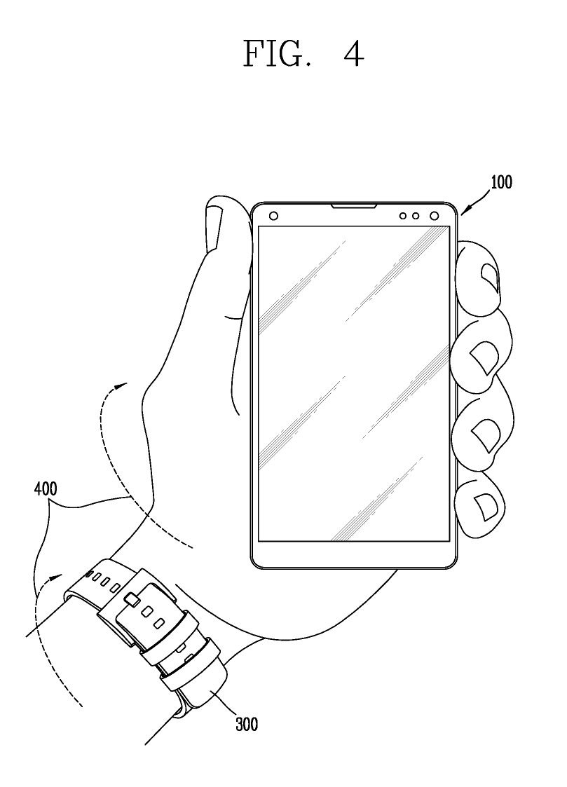

FIG. 4 is a conceptual view illustrating an embodiment in which a mobile terminal and a watch type mobile terminal have the same sensing value according to an embodiment of the present disclosure.

Referring to FIG. 4, after the user wears the watch type mobile terminal 300 on his or her wrist that holds the mobile terminal 100 in his or her hand, the user may make a gesture 400 of turning the wrist in a clockwise direction or in a counterclockwise direction.

Accordingly, a first sensing value sensed by a motion sensor of the mobile terminal 100 and a second sensing value sensed by a motion sensor of the watch type mobile terminal 300 have the same value.

Here, in a case in which the first sensing value and the second sensing value are within a preset specific range, a preset control operation may be performed.

In an embodiment, a user may be authenticated or a function including personal information may be activated. In detail, payment information or log-in information may be automatically input so that payment or log in may be performed only with the gesture. Alternatively, an environment setting value previously set by the user may be loaded or an application may be executed.

A specific embodiment related to the preset control operation will be described hereinafter with reference to the accompanying drawings.

Meanwhile, the wireless communication unit 110 may receive authentication information authenticating the user who has made the preset gesture from the watch type mobile terminal 300.

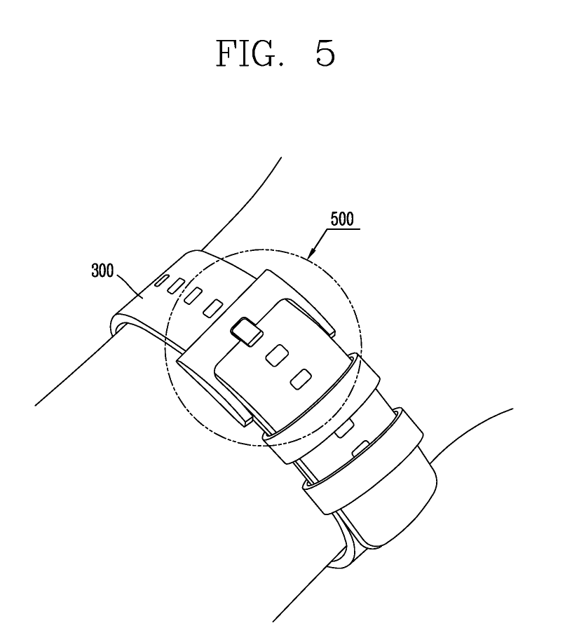

FIG. 5 is a conceptual view illustrating an embodiment in which a user is authenticated in a watch type mobile terminal.

Referring to FIG. 5, when the user wears the watch type mobile terminal 300, a fingerprint of the user may be naturally recognized through a fingerprint recognition sensor disposed in a buckle 500.

In detail, when the recognized fingerprint matches a preset authentication fingerprint, the watch type mobile terminal 300 may transmit authentication information authenticating the user to the wireless communication unit 110.

In another embodiment, a magnetic sensor may be provided in a loop portion of the buckle 50 or in the buckle 50 itself to sense loosening of the buckle 500. When the buckle 500 is loosened, user authentication may be released.

That is, according to the embodiment of FIG. 5, when the user wears the watch type mobile terminal 300, the user may be authenticated, and when the user takes off the watch type mobile terminal 300, the user authentication may be released. As a result, personal information or payment information is prevented from being stolen by the mobile terminal 100 that have a high possibility of being lost.

Hereinafter, embodiments in which the watch type mobile terminal 300 is worn the wrist that holds the terminal 100 will be described, but the present disclosure is not limited thereto. That is, when sensing values are the same or similar, a preset control operation may be executed.

In an embodiment, even in a case in which the watch type mobile terminal 300 is worn on the other hand, rather than on the hand holding the terminal 100, when the same gesture is applied to both hands, the same or similar sensing values may be calculated.

Also, in the following embodiments, it may be assumed that user authentication is completed (first authentication is completed) when the watch type mobile terminal 300 is worn.

Meanwhile, in a state in which the authentication information is received and the first sensing value and the second sensing value are within a preset specific range, the user may be re-authenticated such that the preset control operation is executed on the basis of the data.

In a specific embodiment, in a state in which the authentication information is received and the first sensing value and the second sensing value are within the preset specific range, the control unit 180 may execute a preset banking transaction on the basis of the data.

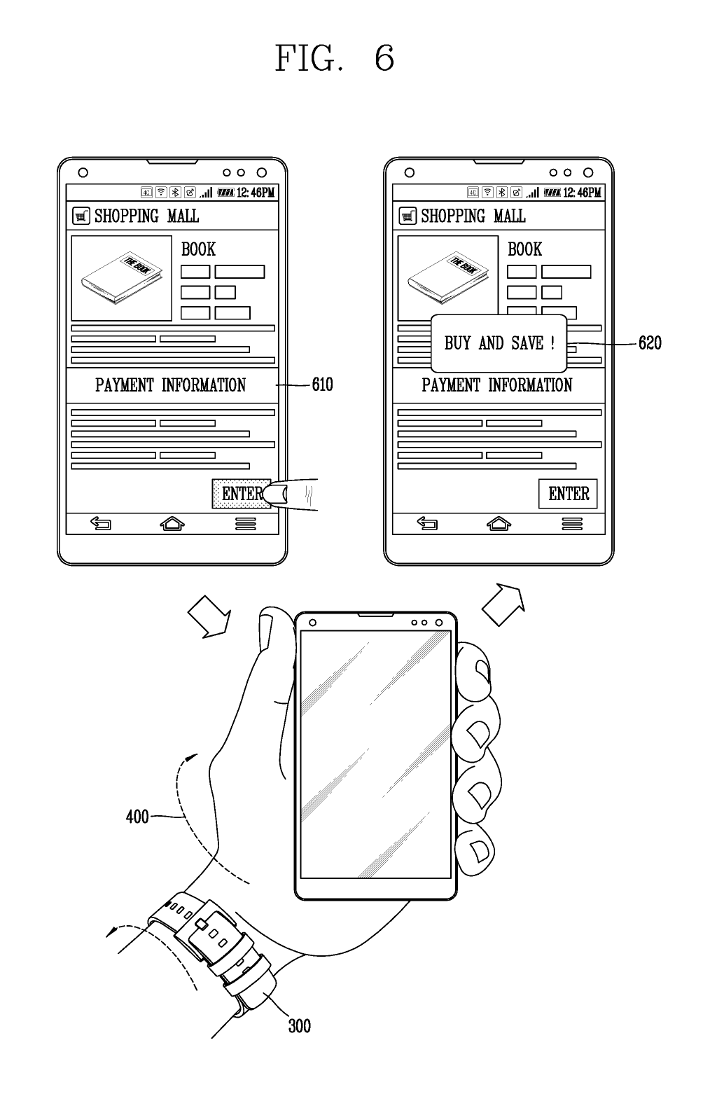

FIG. 6 is a conceptual view illustrating an embodiment in which payment information is stored by a gesture having the same sensing value.

Referring to FIG. 6, the user may select goods to be purchased in a product purchase site and input payment information 610. The payment information 610 may include a destination of the purchased goods, information regarding a payment unit, and the like. In detail, the payment information 610 may include a number of a card for payment, a password, an expiration date, and the like.

Thereafter, as illustrated in FIG. 4, in a state in which the user wears the watch type mobile terminal 300 on his or her wrist that is holding the mobile terminal 100, the user may make a gesture 400 of turning the wrist in a clockwise direction or in a counterclockwise direction

As a result, purchasing goods may be completed, and the input payment information may be stored in the memory 170. Here, the input payment information 610 may be transmitted to and stored in the watch type mobile terminal 300.

Also, a pop-up window 620 indicating that the purchasing goods has been completed and the payment information 610 has been stored may be output on the display unit 151.

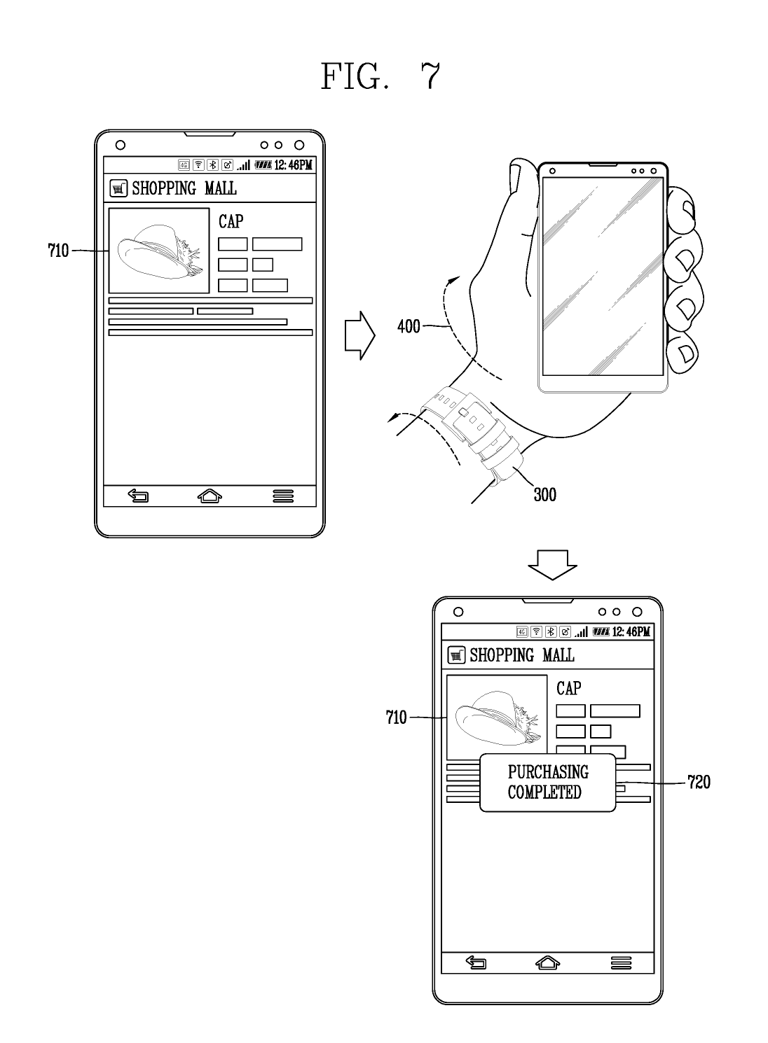

FIG. 7 is a conceptual view illustrating an embodiment in which payment information is used by a gesture having the same sensing value.

Referring to FIG. 7, the user may select goods 710 to be purchased in a goods purchase site, and as illustrated in FIG. 4, in a state in which the watch type mobile terminal 300 is worn on the wrist that is holding the mobile terminal 100, the user may make a gesture 400 of turning the wrist in the clockwise direction or in the counterclockwise direction.

As a result, even though payment information is not input again, the goods 710 may be purchased on the basis of the payment information which was input and stored in FIG. 6. Also, a pop-up window 720 indicating that purchasing goods has been completed may be output on the display unit 151.

In another embodiment, when a gesture 400 of running the wrist in the clockwise direction or in the counterclockwise direction is made, a screen in which the stored payment information is automatically input may be output.

That is, according to the embodiment of FIGS. 6 and 7, when motion sensor values of the mobile terminal 100 and the watch type mobile terminal 300 are the same (action sync), payment may be automatically made.

Meanwhile, in a state in which the authentication information is received and the first sensing value and the second sensing value are within the preset specific range, the control unit 180 may execute a preset application on the basis of the data.

In a specific embodiment, in a state in which the authentication information is received and the first sensing value and the second sensing value are within the preset specific range, the control unit 180 may execute log-in to a preset application on the basis of the data.

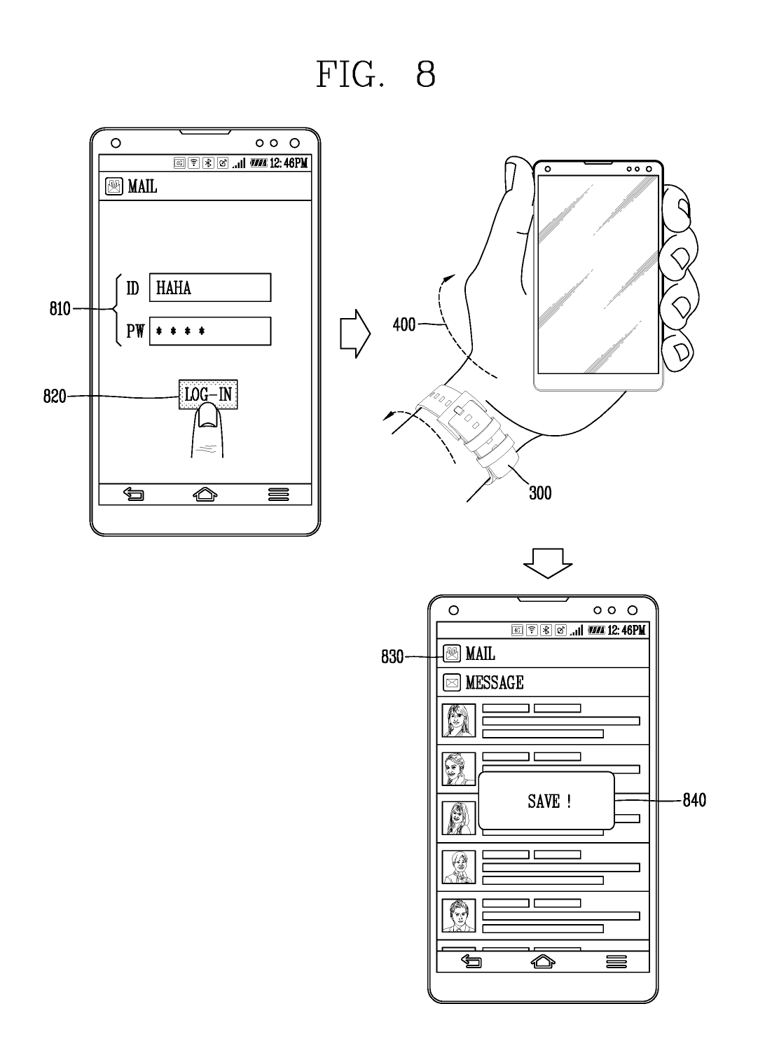

FIG. 8 is a conceptual view illustrating an embodiment in which personal information is stored by a gesture having the same sensing value.

Referring to FIG. 8, in order to log in to a mail application, personal information 810 such as an ID and a password may be input, and a touch input may be applied to a log-in icon 820 to log into the mail application.

Thereafter, as described above with reference to FIG. 4, in a state in which the watch type mobile terminal 300 is worn on the wrist that is holding the mobile terminal 100, the user may make a gesture 400 of turning the wrist in the clockwise direction or in the counterclockwise direction.

As a result, logging may be completed, and the input personal information 810 may be stored in the memory 170. Here, the input personal information 810 may be transmitted to and stored in the watch type terminal 300.

Also, a pop-up window 840 indicating that the execution screen 830 of the logged-in mail application and the personal information 810 have been stored may be output on the display unit 151.

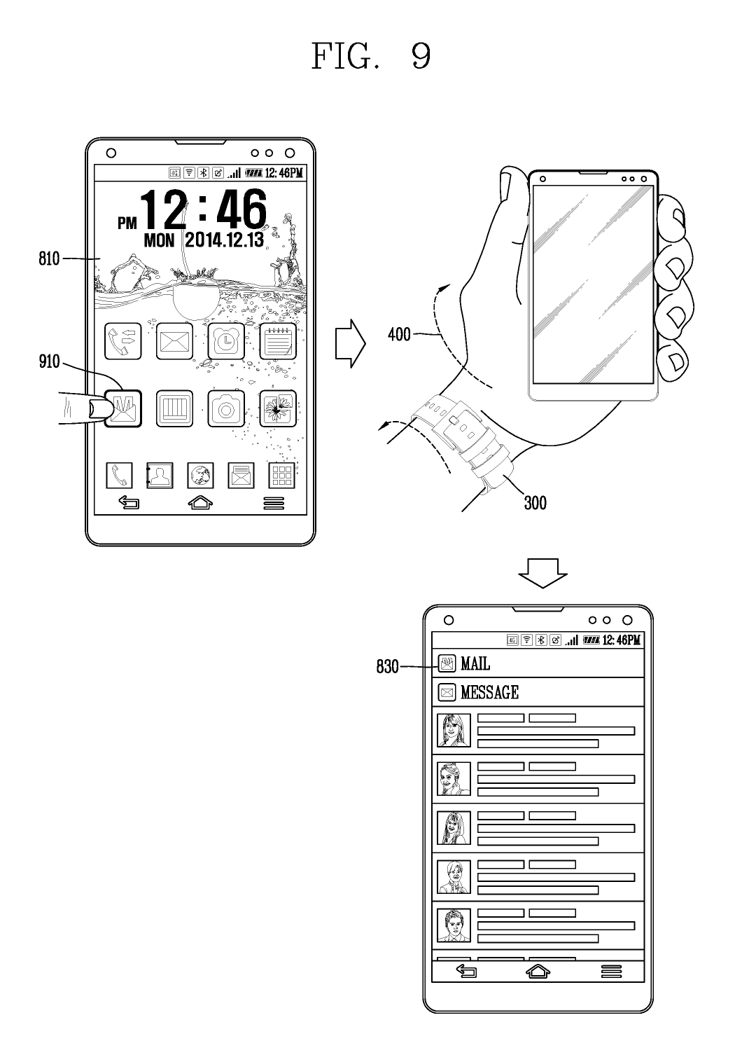

FIG. 9 is a conceptual view illustrating an embodiment in which personal information is used by a gesture having the same sensing value.

Referring to FIG. 9, the user may apply a touch to an icon 910 of the mail application to execute the mail application, and as described above with reference to FIG. 4, in a state in which the watch type mobile terminal 300 is worn on the wrist that is holding the mobile terminal 100, the user may make a gesture 400 of turning the wrist in the clockwise direction or in the counterclockwise direction.

As a result, even though personal information is not input again, logging in may be completed on the basis of the personal information which has been input and stored as illustrated in FIG. 8, and an execution screen 830 of the logged-in mail application may be output.

In another embodiment, when the gesture 400 of turning the wrist is made, a screen in which the stored personal information is automatically input may be output.

That is, according to the embodiment of FIGS. 8 and 9, when motion sensor values of the mobile terminal 100 and the watch type mobile terminal 300 are the same (action sync), log-in information (personal information) may be automatically input when an application requiring log-in is executed.

Meanwhile, in a state in which the authentication information is received and the first sensing value and the second sensing value are within the preset specific range, the control unit 180 may output preset visual information on the basis of the data.

In a specific embodiment, in a state in which the authentication information is received and the first sensing value and the second sensing value are within the preset specific range, the control unit 180 may output an icon of a preset application on the basis of the data.

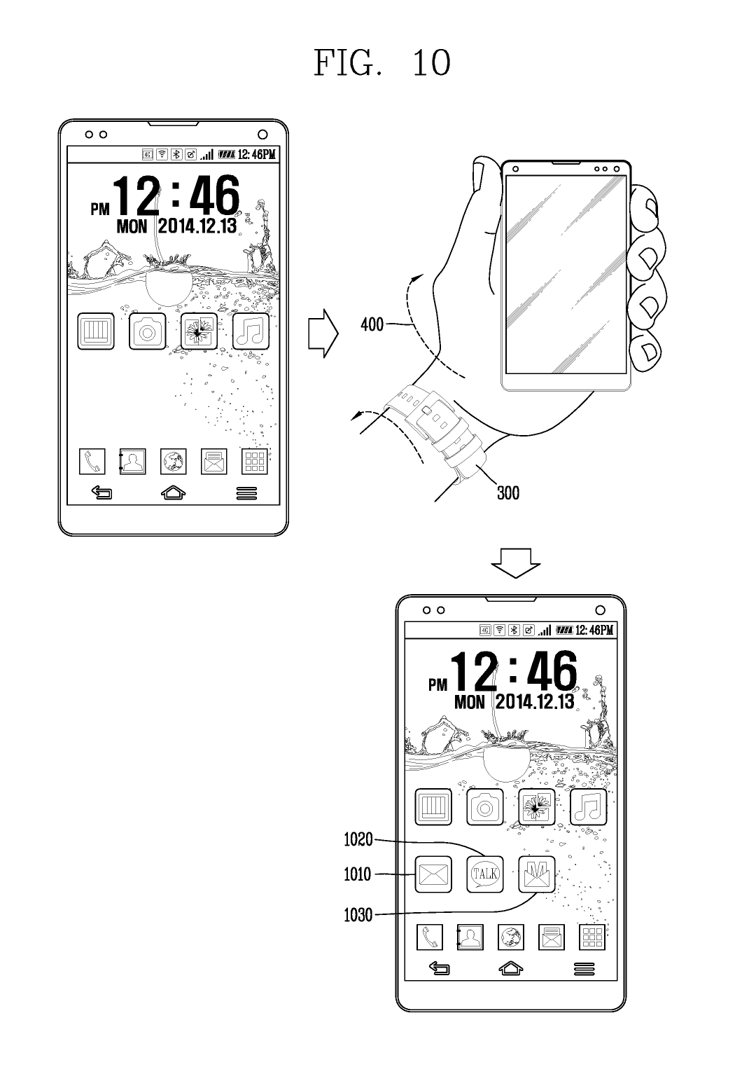

FIG. 10 is a conceptual view illustrating an embodiment in which an icon of a preset application is output by a gesture having the same sensing value.

Referring to FIG. 10, the user may wear the watch type mobile terminal 300 on the wrist that is holding the mobile terminal 100. Here, a home screen may be output on the mobile terminal 100.

Thereafter, as described above with reference to FIG. 4, in a state in which the watch type mobile terminal 300 is worn on the wrist that is holding the mobile terminal 100, the user may make a gesture 400 of turning the wrist in the clockwise direction or in the counterclockwise direction.

Accordingly, icons 1010, 1020, and 1030 of a preset application may be output on the home screen.

According to the embodiment of FIG. 10, it is possible for the user to hide an application that the user does not want to show others or an application that has a possibility of leaking personal information, among applications used by the user usually.

Thereafter, when motion sensor values of the mobile terminal 100 and the watch type mobile terminal 300 are the same (action sync), an icon of the hidden application may be output.

Meanwhile, when the preset gesture is applied, the wireless communication unit 110 may transmit an environment setting value of the terminal 100 to the watch type mobile terminal 300.

Also, in a state in which the authentication information is received and the first sensing value and the second sensing value are within the preset specific range, the control unit 180 may set the environment setting value of the mobile terminal with a value transmitted from the watch type mobile terminal 300.

That is, set values of a first terminal 100-1 that the user usually uses, for example, a Wi-Fi password, a bookmark, alarm, a ring tone, brightness, and the like, may be stored in the first terminal 100-1 and the watch type mobile terminal 300 through action sync.

Thereafter, after the watch type mobile terminal 300 is worn on the wrist that is holding a second terminal 100-2, the user may apply a gesture to perform the action sync. Accordingly, the set values may be automatically loaded to the second terminal 100-2.

That is, the second terminal 100-2 may have the same set value as that of the first terminal 100-1. Thus, the user may temporarily use the terminal 100 or may continuously use the previously used set value even after a device is changed.

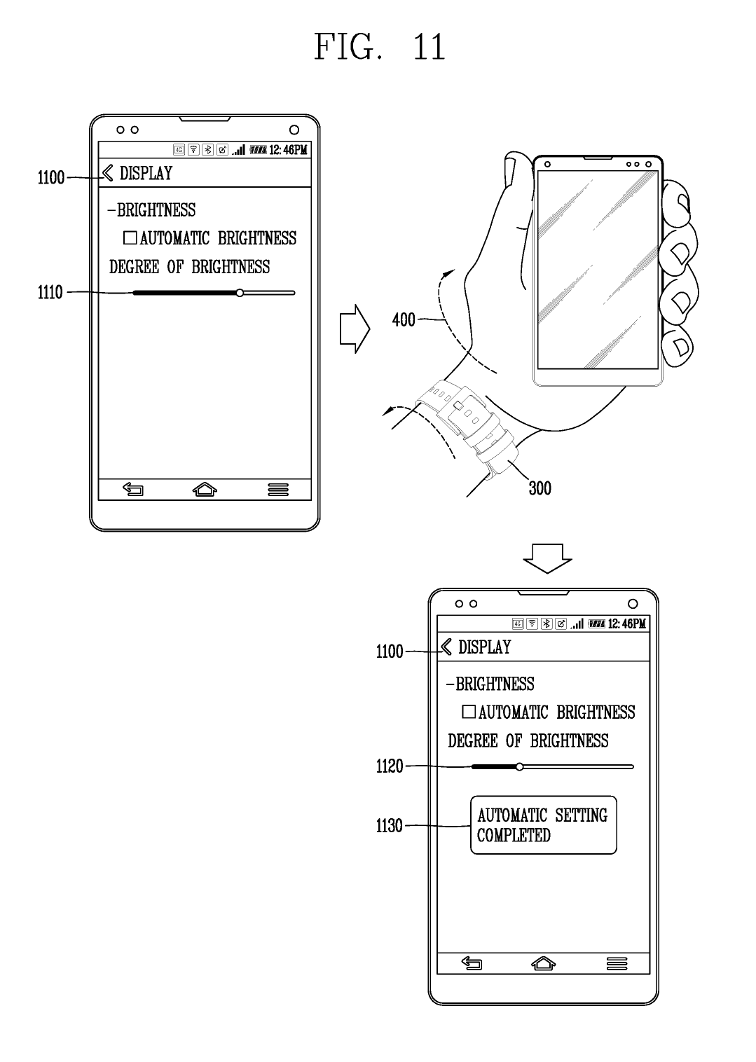

FIG. 11 is a conceptual view illustrating an embodiment in which a brightness value is set by a gesture having the same sensing value.

Referring to FIG. 11, the user may wear the watch type mobile terminal 300 on the wrist that is holding the mobile terminal 100. Here, a display 151 environment setting screen 1100 including a graph 1110 indicating a degree of brightness of the current screen 151 may be output on the mobile terminal 100.

Thereafter, as described above with reference to FIG. 4, in a state in which the watch type mobile terminal 300 is worn on the wrist that is holding the mobile terminal 100, the user may make a gesture 400 of turning the wrist in the clockwise direction or in the counterclockwise direction.

Accordingly, a brightness set value may be received from the watch type mobile terminal 300, and brightness of the terminal 100 may be set with the received value. In an embodiment, a graph 1120 indicating a degree of brightness of the received set value may be output, and a pop-up window 1130 indicating that brightness is automatically set may be output.

Meanwhile, when a preset touch input is applied to visual information output on the display unit 151 and the preset gesture is subsequently applied thereto, the wireless communication unit 110 may transmit the visual information to the watch type mobile terminal 300.

Thereafter, when a preset touch input is applied to one region of a display unit 351 provided in the watch type mobile terminal 300 and the preset gesture is applied again, the control unit 180 may control the watch type mobile terminal 300 to output the visual information in the one region.

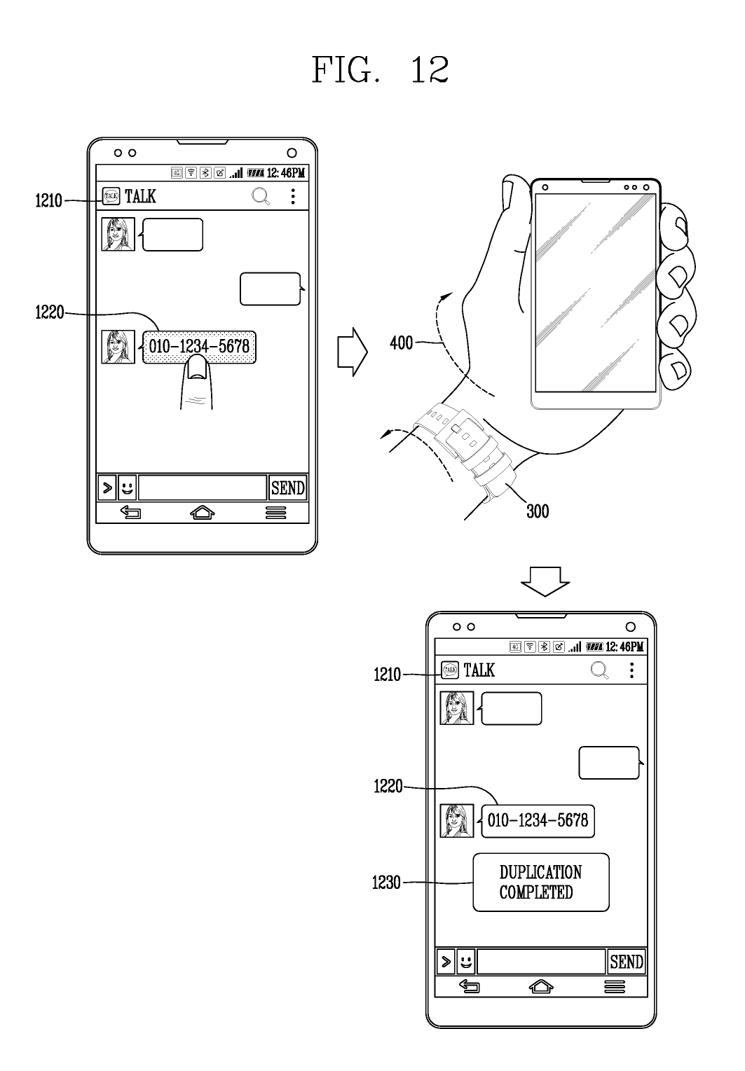

FIG. 12 is a conceptual view illustrating an embodiment in which text is duplicated by a gesture having the same sensing value.

Referring to FIG. 12, the user may wear the watch type mobile terminal 300 on the wrist that is holding the mobile terminal 100. Here, a messenger conversation screen 1210 may be output on the mobile terminal 100.

In this state, the user may apply a touch input to a contact number 1220 in the messenger conversation contents, and thereafter, as described above with reference to FIG. 4, in a state in which the watch type mobile terminal 300 is worn on the wrist that is holding the mobile terminal 100, the user may make a gesture 400 of turning the wrist in the clockwise direction or in the counterclockwise direction.

Accordingly, the contact number may be duplicated and stored, and the stored contact number may be transmitted to the watch type mobile terminal 300. Also, a pop-up window 1230 indicating that duplication has been completed may be output.

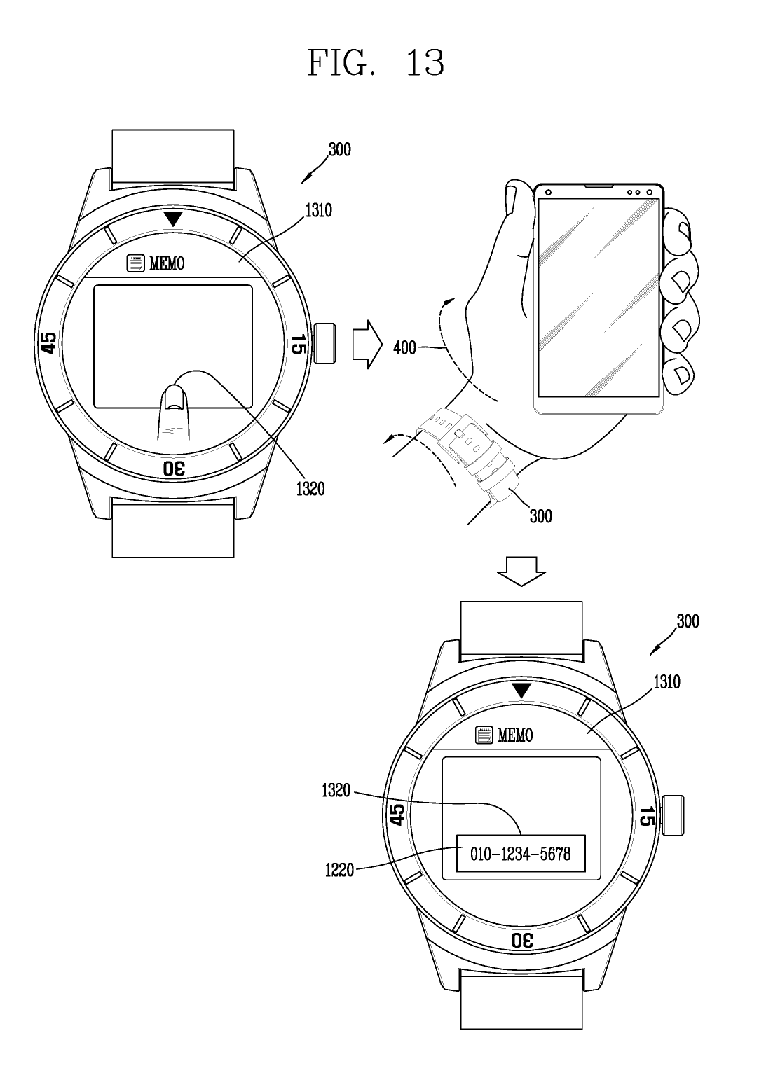

FIG. 13 is a conceptual view illustrating an embodiment in which text is pasted by a gesture having the same sensing value.

Referring to FIG. 13, the user may wear the watch type mobile terminal 300 on the wrist that is holding the mobile terminal 100. Here, an execution screen 1310 of a memo application may be output on the screen 351 of the watch type mobile terminal 300.

Thereafter, the use may apply a touch input to one region 1320 of the execution screen 1310 of the memo application, and thereafter, as described above with reference to FIG. 4, in a state in which the watch type mobile terminal 300 is worn on the wrist that is holding the mobile terminal 100, the user may make a gesture 400 of turning the wrist in the clockwise direction or in the counterclockwise direction.

As a result, the contact number 1220 which was copied in FIG. 12 may be output on the one region 1320 to which the touch input has been applied.

According to the embodiment of FIGS. 12 and 13, when the user makes an action sync motion in a state in which (or after) the user touches specific text or image while using the terminal 100, the touched specific text or image may be duplicated to the watch type mobile terminal 300.

Thereafter, after a touch input is applied to a different application or an inputtable portion, when the user makes the action sync motion, the duplicated specific text image, or the like, may be pasted.

Meanwhile, in a state in which the authentication information is received and the first sensing value and the second sensing value are within a preset first specific range, the control unit 180 may execute a preset first control operation on the basis of the data, and in a state in which the authentication information is received and the first sensing value and the second sensing value are within a second preset specific range, the control unit 180 may execute a preset second control operation on the basis of the data.

That is, control operations may be performed in different manners according to sensing values.

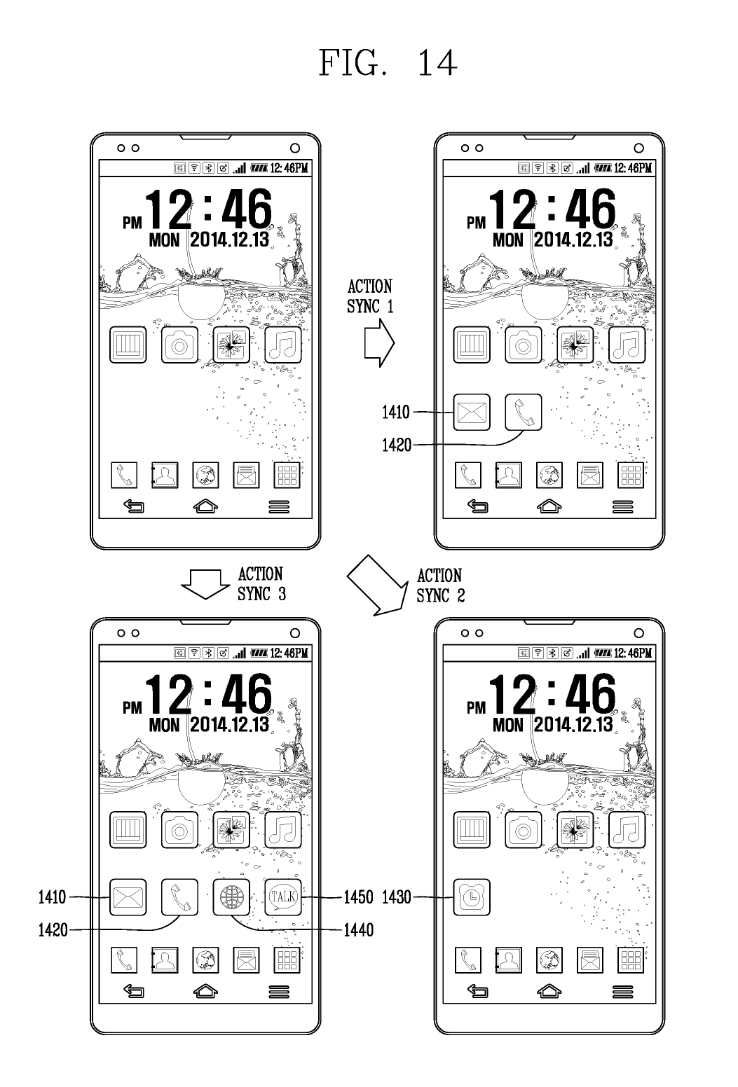

FIG. 14 is a conceptual view illustrating an embodiment in which icons of different applications are output according to sensing values.

Referring to FIG. 14, the user may wear the watch type mobile terminal 300 on the wrist that is holding the mobile terminal 100. Here, a home screen may be output on the mobile terminal 100.

Thereafter, in a state in which the watch type mobile terminal 300 is worn on the wrist that is holding the mobile terminal 100, the user may make a gesture (action sync 1) of turning the wrist at about 60 degrees in the clockwise direction.

Accordingly, icons 1410 and 1420 of preset first and second applications may be output.

In another embodiment, in a state in which the user wears the watch type mobile terminal 300 on the wrist that is holding the mobile terminal 100, the user may make a gesture 400 (action sync 2) of turning the wrist at about 60 degrees in the counterclockwise direction.

Accordingly, an icon 1430 of a preset third application may be output.

In another embodiment, in a state in which the user wears the watch type mobile terminal 300 on the wrist that is holding the mobile terminal 100, the user may make a gesture 400 (action sync 3) of turning the wrist at about 120 degrees in the clockwise direction.

Accordingly, icons 1440 and 1450 of fourth and fifth applications may be output together with the icons 1410 and 1420 of the first and second applications.

According to an embodiment of FIG. 14, in a state in which the user wears the watch type mobile terminal 300 on the wrist that is holding the mobile terminal 100, icons of different applications may be output according to directions in which the wrist is turned or according to angles at which the wrist is turned.

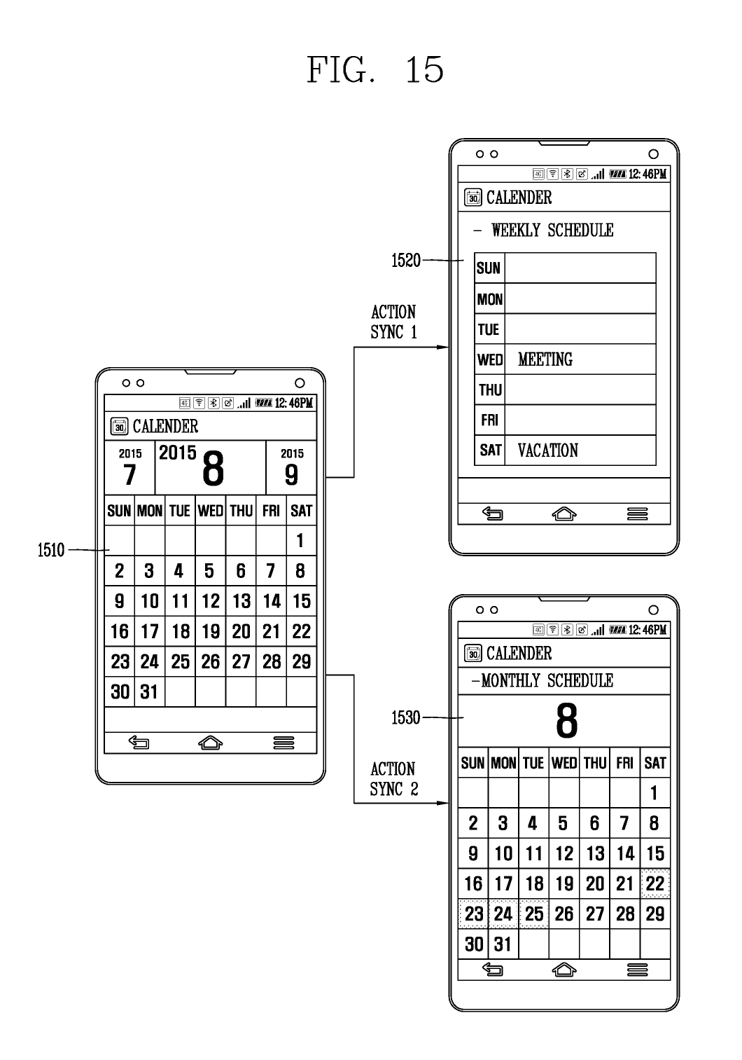

FIG. 15 is a conceptual view illustrating an embodiment in which execution screens of different schedule applications are output according to sensing values.

Referring to FIG. 15, the user may wear the watch type mobile terminal 300 on the wrist that is holding the mobile terminal 100. Here, an execution screen 1510 of a schedule application may be output on the mobile terminal 100.

Thereafter, in a state in which the user wears the watch type mobile terminal 300 on the wrist that is holding the mobile terminal 100, the user may make a gesture (action sync 1) of turning the wrist in the clockwise direction at a first speed range. Accordingly, a screen 1520 for setting a weekly schedule may be output.

In another embodiment, in a state in which the user wears the watch type mobile terminal 300 on the wrist that is holding the mobile terminal 100, the user may make a gesture (action sync 2) of turning the wrist in the clockwise direction at a second speed range. Accordingly, a screen 1530 for setting a monthly schedule may be output.

According to the embodiment of FIG. 15, in a state in which the user wears the watch type mobile terminal 300 on the wrist that is holding the mobile terminal 100, different schedule setting screens may be output according to speeds at which the user turns his or her wrist.

The mobile terminal and the method of controlling the same according to embodiments of the present disclosure have the following advantages.

According to at least one of the embodiments of the present disclosure, personal information may be protected and the risk of unauthorized payment or unauthorized use may be prevented, and in addition, a control operation may be performed only by a specific action.

Also, according to at least one of the embodiments of the present disclosure, even while a user is using another terminal, the user may use an environment of a previous terminal simply.

In addition, a personalized user interface may be output or a frequently used function may be executed only by a specific action.

As a result, user convenience may be enhanced.

The present invention described above may be implemented as a computer-readable code in a medium in which a program is recorded. The computer-readable medium includes any type of recording device in which data that can be read by a computer system is stored. The computer-readable medium may be, for example, a hard disk drive (HDD), a solid state disk (SSD), a silicon disk drive (SDD), a ROM, a RAM, a CD-ROM, a magnetic tape, a floppy disk, an optical data storage device, and the like. The computer-readable medium also includes implementations in the form of carrier waves (e.g., transmission via the Internet). Also, the computer may include the controller 180 of the terminal. Thus, the foregoing detailed description should not be interpreted limitedly in every aspect and should be considered to be illustrative. The scope of the present invention should be determined by reasonable interpretations of the attached claims and every modification within the equivalent range are included in the scope of the present invention.

The foregoing embodiments and advantages are merely exemplary and are not to be considered as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds are therefore intended to be embraced by the appended claims.

What is claimed is:

1. A mobile terminal comprising:
a control unit to store data for executing a preset control operation when a preset gesture is detected;
a sensing unit to detect the preset gesture and to calculate a first sensing value based on the preset gesture; and
a wireless communication unit to receive a second sensing value calculated by an external terminal also detecting the preset gesture,
wherein, when the first sensing value and the second sensing value are within a preset specific range, the control unit executes the preset control operation on the basis of the data.

2. The mobile terminal of claim 1, wherein the wireless communication unit receives a sensing value, calculated based on the preset gesture in a watch type external terminal worn on the wrist that is holding the mobile terminal, as a second sensing value.

3. The mobile terminal of claim 2, wherein the wireless communication unit receives authentication information, authenticating a user who has made the preset gesture, from the watch type external terminal.

4. The mobile terminal of claim 3, wherein, in a state in which the authentication information is received and the first sensing value and the second sensing value are within the preset specific range, the control unit re-authenticates the user such that the preset control operation is executed on the basis of the data.

5. The mobile terminal of claim 4, wherein, in a state in which the authentication information is received and the first sensing value and the second sensing value are within the preset specific range, the control unit executes a preset banking transaction on the basis of the data.

6. The mobile terminal of claim 4, wherein, in a state in which the authentication information is received and the first sensing value and the second sensing value are within the preset specific range, the control unit executes a preset application on the basis of the data.

7. The mobile terminal of claim 6, wherein, in a state in which the authentication information is received and the first sensing value and the second sensing value are within the preset specific range, the control unit executes a log in to a preset application on the basis of the data.

8. The mobile terminal of claim 4, wherein, in a state in which the authentication information is received and the first sensing value and the second sensing value are within the preset specific range, the control unit outputs preset visual information on the basis of the data.

9. The mobile terminal of claim 8, wherein, in a state in which the authentication information is received and the first sensing value and the second sensing value are within the preset specific range, the control unit outputs an icon of a preset application on the basis of the data.

10. The mobile terminal of claim 4, wherein when the preset gesture is detected, the wireless communication unit transmits an environment setting value of the terminal to the watch type external terminal.

11. The mobile terminal of claim 4, wherein, in a state in which the authentication information is received and the first sensing value and the second sensing value are within the preset specific range, the control unit sets an environment setting value of the mobile terminal with a value transmitted from the watch type external terminal.

12. The mobile terminal of claim 4, wherein, after a preset touch input is applied to visual information output on the display unit, when the preset gesture is detected, the wireless communication unit transmits the visual information to the watch type external terminal.

13. The mobile terminal of claim 12, wherein, after a preset touch input is applied to one region of a display unit provided in the watch type external terminal, when the preset gesture is detected, the control unit controls the watch type external terminal to output the visual information on the one region.

14. The mobile terminal of claim 4, wherein,
in a state in which the authentication information is received and the first sensing value and the second sensing value are within a preset first specific range, the control unit performs a preset first control operation on the basis of the data, and
in a state in which the authentication information is received and the first sensing value and the second sensing value are within a preset second specific range, the control unit performs a preset second control operation on the basis of the data.

15. A method of controlling a mobile terminal, the method comprising:
storing, in a control unit, data for executing a preset control operation when a preset gesture is detected;
detecting, by a sensing unit, the preset gesture, and upon detection, calculating a first sensing value based on the preset gesture; and
receiving, by a wireless communication unit, a second sensing value calculated by an external terminal also detecting the preset gesture,
wherein, when the first sensing value and the second sensing value are within a preset specific range, executing the preset control operation on the basis of the data.

16. The method of claim 15, wherein the receiving a second sensing value comprises:
receiving a sensing value, calculated based on the preset gesture from a watch type external terminal worn on the wrist that is holding the mobile terminal, as the second sensing value.

17. The method of claim 16, further comprising:
receiving authentication information, authenticating a user who has made the preset gesture, from the watch type external terminal.

18. The method of claim 17, wherein in a state in which the authentication information is received and the first sensing value and the second sensing value are within the preset specific range:
re-authenticating the user such that the preset control operation is executed on the basis of the data.

19. The method of claim 18, wherein in a state in which the authentication information is received and the first sensing value and the second sensing value are within the preset specific range:
executing a preset banking transaction on the basis of the data.

20. The method of claim 18, wherein in a state in which the authentication information is received and the first sensing value and the second sensing value are within a preset first specific range:
executing a first preset control operation on the basis of the data, and
wherein in a state in which the authentication information is received and the first sensing value and the second sensing value are within a preset second specific range:
executing a second preset control operation on the basis of the data.
